(19) United States
(12) Patent Application Publication
(10) Pub. No.: US 2005/0055563 A1
(43) Pub. Date: Mar. 10, 2005

(54) Device and method for generating an operation code

(76) Inventors: Wieland Fischer, Munich (DE); Jean-Pierre Seifert, Munich (DE)

Correspondence Address: SLATER & MATSIL LLP, 17950 PRESTON ROAD, SUITE 1000, DALLAS, TX, 75252, US

(21) Appl. No.: 10/898,154

(22) Filed: Jul. 23, 2004

Related U.S. Application Data
(63) Continuation of application No. PCT/EP03/00689, filed on Jan. 23, 2003.

(30) Foreign Application Priority Data
Jan. 24, 2002 (DE) 102 02 700.5

(51) Int. Cl. H04L 9/00

(52) U.S. Cl. 713/194

(57) ABSTRACT

A device for generating an operation code having a plurality of operation code words includes a means for providing an operation group with operations from a set of operations, wherein the operations from the operation group are performable alternatively to one another depending on a decision within a program. The device further includes a means for associating operation code words with the operations of the operation group, wherein the associated code words are different from one another and implemented such that a characteristic of a circuit depending on a processing of the operation code words is located within a predetermined range for the operation code words of the operation group. Decisions within the program which depend on secret data may therefore not be tapped any more by detecting the characteristic, like for example a current reception of a circuit, by side-channel attacks, so that a cryptoprocessor works more efficient and safe without an additional circuit complexity.

### CROSS-REFERENCE TO RELATED APPLICATIONS

This application is a continuation of co-pending International Application No. PCT/EP03/00689, filed Jan. 23, 2003, which designated the United States and was not published in English.

### BACKGROUND OF THE INVENTION

1. Field of the Invention

The present invention relates to cryptography processors and in particular to protective measures for cryptography processors.

2. Description of the Related Art

In cryptographic programs the flow of a program directly depends on secret data. The secret data is to be protected against attacks to the cryptographic programs. The safety of a cryptographic program is deemed to be high if secret data may for example only be determined by so-called “brute force” attacks. Such attacks consists of trying any possibility in order to then determine the secret data—seen statically—when all available possibilities have been tried. For protecting against such as attacks usually very long numbers are processed in cryptographic algorithms, so that it is only possible to “crack” the cryptoalgorithm with an astronomically high time effort.

Apart from that, further so-called side-channel attacks exist which try to get secret data from a cryptoprocessor a different way. Such side-channel attacks for example consist of detecting the electromagnetic radiation of a cryptoprocessor while the same is executing a cryptoprogram. A further characteristic of the cryptoprocessor which may be detected within the frame of a side-channel attack is for example the current consumption of a circuit, the power consumption of the circuit, the heating up of the circuit, the time which the circuit needs for performing a program, etc.

Generally, a side-channel attack may be performed on any characteristic of the circuit, which depends on a processing of a sequence of operations of the cryptographic algorithm. The reason therefore is that if the characteristic of a circuit depends on the cryptographic algorithm, the cryptographic algorithm itself and in particular secret data which are processed in the cryptographic algorithm may be concluded from the detected characteristic.

In FIG. 7 the so-called non-restoring division algorithm is illustrated schematically, as it is described in “Computer Architecture: A Quantitative Approach”, Hennessy and Patterson, Morgan Kaufmann Publishers, Inc., 1996, Appendix A.2. This division algorithm may be used within a cryptographic algorithm in order to calculate the result of the division of the numerator a and the denominator b. For this usually three registers A, B, P are used. In every iteration step first the register pair P, A is shifted one bit to the left. Then a case differentiation is performed whose result depends on the fact whether the present content of the register P is negative or not. If the content of the register P is negative then the content of the register B is added to the register P. If, however, the content of the register P is positive, then the content of the register B is. subtracted from the content of the register P. Generally this means, if it is assumed, that sensitive data is in the register P, the operation which is to be performed by a processor, i.e. adding or subtracting, depends on the sensitive data within the register P. If the processor comprises a characteristic, like for example a current consumption, which is different to the case wherein the processor performs a subtracting operation when the processor performs an adding operation, then referring to the power consumption it may be concluded whether the content of the register P is negative or positive. These conclusions are to be prevented, however, as the register P contains sensitive data.

As it is illustrated in FIG. 7, the non-restoring division algorithm is continued after step 2 by the fact that the least significant bit is set from A to 0, again in case the content of the register P which resulted after step 2 is negative, while when the content of the register P is positive the least significant bit is set from A to 1. If the processor in turn comprises a different characteristic for the action of setting the least significant bit of a register to 0 or of setting the least significant bit of a register to 1, then again the register content P may be concluded by detecting the characteristic of the processor, which is also to be prevented, however, because the register P contains sensitive data which is important for the safety of the cryptoalgorithm in which the division algorithm shown in FIG. 7 is performed.

The division algorithm shown in FIG. 7 was only illustrated as an example. In principle, every cryptoalgorithm contains locations in which the sequence of operations, i.e. either subtraction or addition, depends on secret data. If the characteristic of the processor for such operations which are to be performed alternatively to each other is different for the operation alternatives, wherein the selection of the alternative depends on secret data, then the processor is open for side-channel attacks, because via a detection of the characteristic of the processor, typically coupled with a plurality of renewed calculations for the processor and a subsequent statistic evaluation, the secret data may be concluded.

Such attacks are described in “Investigations of power analysis attacks on smart cards”, P. S. Messerges et al., Proceedings of USENIX Workshop on Smart Card Technology, May 1999, pp. 151-161.

In the art several approaches exist in order to disguise the current consumption of a cryptoprocessor. If the cryptoprocessor is for example constructed in an CMOS architecture, then the current consumption of the cryptoprocessor corresponds to the number of switching processes, i.e. how often a CMOS inverter is switched from a logical 0 state to a logical 1 state. In order to randomize a deterministic current consumption of a cryptoprocessor, for example dummy operations may be inserted into the operation sequence, so that it is made hard for the attacker to draw conclusions to the sensitive data, as he does not know which current consumptions result from a dummy operation and which current consumptions in the current profile result from an actual operation of the cryptographic algorithm.

A further possibility is the complete dual rail approach, wherein the calculation is performed with complementary data, expressed in a simplified way.

Disadvantageous about all these methods is, that they are not useable universally, that they comprise a high chip area consumption and in addition to that a high power consumption, wherein these disadvantages are serious, in particular with chip cards, because here the chip area is strongly restricted and also the current consumption is limited upwards for an increasing number of emerging contactless applications.

### SUMMARY OF THE INVENTION

It is the object of the present invention to provide a safe and efficient operation code concept.

In accordance with a first aspect, the present invention provides a device for generating an operation code comprising a plurality of operation code words, wherein each operation code word is associated with an operation from a set of operations, having a provider for providing an operation group comprising operations from an operation set, wherein the operations from the operation group are to be performed alternatively to each other depending on a decision within a program; and an allocating unit for allocating operation code words to the operations of the operation group, wherein the allocated code words are different from each other and implemented such that a characteristic of a circuit detectable by measuring, which depends on a processing of the operation code words, lies within a predetermined range for the operation code words of the operation group, wherein the predetermined range is small or substantially zero.

In accordance with a second aspect, the present invention provides a method for generating an operation code comprising a plurality of operation code words, wherein each operation code word is associated with an operation from a set of operations, with the steps of providing an operation group comprising operations from an operation set, wherein the operations from the operation group are performable alternatively to one another depending on a decision within a program; and allocating of operation code words to the operations of the operation group, wherein the allocated code words are different from one another and implemented such that a characteristic of a circuit detectable by measuring, which depends on a processing of the operation code words lies in a predetermined range for the operation code words of the operation group, wherein the predetermined range is small or substantially zero.

In accordance with a third aspect, the present invention provides a device for performing a program with a sequence of operations according to the above mentioned device.

In accordance with a fourth aspect, the present invention provides a method for performing a program with a sequence of operations according to the above mentioned method.

In accordance with a third aspect, the present invention provides a storage with a stored operation code generated according to the above mentioned method.

The present invention is based on the findings that by determining an operation code for a cryptographic processor, the cryptographic processor may be protected against attacks. According to the invention, an operation set is grouped into operation groups, wherein in each operation group the operations are contained which are performed by a program alternatively to each other, i.e. by performing the same conclusions may be drawn to sensitive data within the program. According to the invention, the operation code is selected such that the operations within an operation group are represented by operation code words, wherein during the processing of the same by a processor circuit properties of the processor circuit are conditioned by a processor circuit for any operation within an operation group, which lies within a predetermined range, wherein the predetermined range equals 0 in a preferred embodiment of the present invention.

In other words this means, that for processing any operation code words of operations within a group the circuit comprises the same characteristic, i.e. the same current consumption, the same power consumption, the same electromagnetic radiation, the same time consumption, the same heating up etc. when processing these operation code words. Therefore, when the predetermined range is selected to be small, it is only possible with an extreme effort to perform side-channel attacks against a cryptoprocessor working with the inventive operation code, wherein the soundness of such side-channel attacks is continuously reduced the smaller the predetermined range is. In the case in which the characteristic of the processor is the same for all operation code words in an operation group, the effect of side-channel attacks disappears.

In a preferred embodiment of the present invention, the operation code words of a group are selected so that they comprise an identical Hamming weight, i.e. that the number of ones in a binary operation code word is identical for all operation code words within an operation group.

### BRIEF DESCRIPTION OF THE DRAWINGS

These and other objects and features of the present invention will become clear from the following description taken in conjunction with the accompanying drawings, in which:

FIG. 1 shows a schematical illustration of a device and a method for generating an operation code;

FIG. 2 shows a schematical illustration of a device and a method for performing a program with a sequence of operations;

FIG. 3 shows a schematical illustration of a cryptographic algorithm, wherein the operations B1 and B2 are performed alternatively to each other depending on the sensitive data P and therefore form an operation group;

FIG. 4 shows a table for different operation types and associated hexadecimal or binary codes;

FIG. 5 shows a table for illustrating different operation parameters having associated hexadecimal and binary codes;

FIG. 6 shows a table for illustrating an exemplary operation group and several exemplary operation groups, respectively; and

FIG. 7 shows an overview of the known non-restoring division algorithm.

### DESCRIPTION OF THE PREFERRED EMBODIMENTS

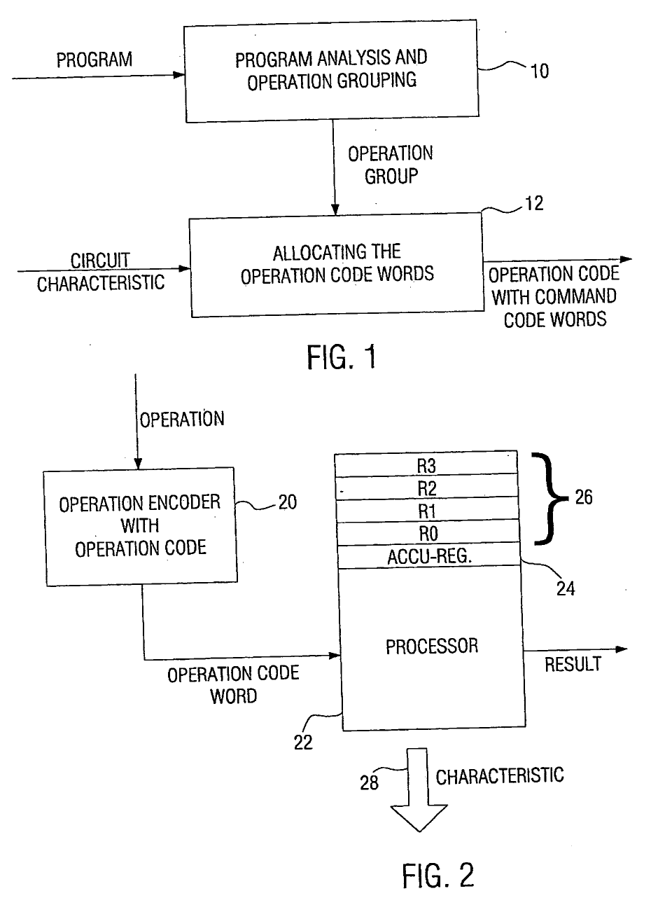

FIG. 1 shows an inventive device for generating an operation code comprising a plurality of operation code words, wherein each operation code word is associated with an operation from an operation set. First of all, the inventive device includes a means 10 for providing an operation group, wherein the operation group includes operations from the operation set, which are performable alternatively to each other depending on a decision in a program to be processed. The inventive device further includes a means 12 for allocating operation code words to the operations of the operation group, wherein the allocated code words are different from each other and are further implemented such that a characteristic of a circuit depending on a processing of the operation code word lies within a predetermined range for the operation code words of the operation group. The means 12 generates an operation code with operation code words as an output which may be used by a processor, which executes a cryptographic program using the inventive operation code, which is safer against side-channel attacks and in the optimum case safe, in which the characteristic of the circuit is basically identical for all operation code words of an operation code, respectively, so that side-channel attacks are principally without effect.

At this point it is to be noted that the characteristic of a circuit comprising a circuit when performing an operation code word, may for example be the current consumption of the circuit, the power consumption of the circuit, the time requirement of the circuit or the electromagnetic radiation of the circuit, wherein as a special case of the electromagnetic radiation also the heating up of the circuit is to be mentioned, if it is detectable.

Operation code words in an operation group are defined so that a circuit, like for example a processor on a smart card which processes an operation code word comprises a certain characteristic, like for example a certain current consumption, which is preferably identical to the current consumption of the circuit, if the same performs a different operation code word which is associated with an operation from the same operation group.

FIG. 2 shows a schematical illustration of a device for performing a program with a sequence of operations, wherein the operation code generated for example according to FIG. 1 is used. An operation of a program is supplied to an operation encoder 20, in which the operation code output by means 12 from FIG. 1 is stored. The operation encoder 20 outputs an operation code word which is supplied to a processor 22 for processing the operation code word. The processor may for example include an accumulator register 24 and further registers 26, which are designated with R0, R1, R2 and R3 in FIG. 2. The processor outputs an event which was generated by performing the operation, i.e. by processing the operation code word. When processing the operation code word the processor 22 shows a special characteristic 28 which is identical for processing the operation code word of one operation group in a preferred embodiment of the present invention, as it was performed, so that side-channel attacks, which are built on the characteristic 28 of the processor 22 must remain without effect.

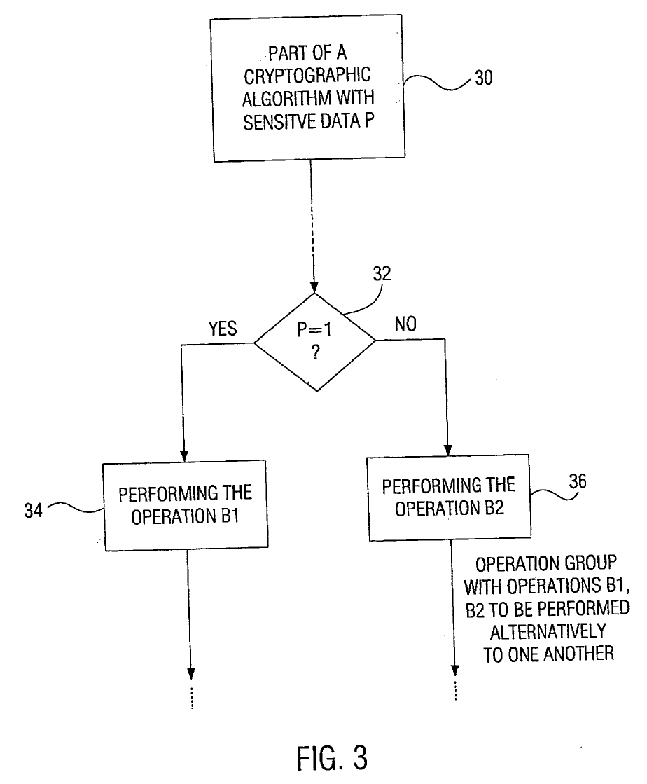

FIG. 3 schematically shows a cryptoalgorithm, i.e. a program which is analyzed in a preferred embodiment of the present invention in order to determine which operations should come into one operation group, so that operation code words are associated with the same, wherein a processor preferably comprises an identical characteristic when processing the same. The cryptoalgorithm illustrated in FIG. 3 as an example for a program includes a part 30 of the cryptographic algorithm, a decision block 32 and two operations 34 and 36 which are to be performed alternatively to each other. Within the decision block 32 it is for example examined whether the sensitive information, like for example a bit P, includes a logical “1” or a logical “0”. If this question is answered by “yes”, then operation B1 is to be performed (step 34), while when the question in the decision block (32) is answered by “no”, then the operations B2 will have to be performed (36). The operations B1 and B2 are therefore operations to be performed alternatively and are therefore grouped into the same single operation group.

Depending on the case of application, the grouping of the operations into operation groups may either be performed specifically for each program in order to obtain the optimum safety, which will in particular be the case with chip card applications. Alternatively, however, also an operation grouping according to experience aspects may be performed in order to at least improve the safety of existing programs, so that not every program must be analyzed individually regarding its decisions and operations to be performed alternatively, but that an operation code is used which at least includes the prevailing majority of operation alternatives according to FIG. 3 according to experience aspects for many programs which are considered. Even if not all operations to be performed alternatively are located within a cryptographical program with a plurality of decisions according to FIG. 3 within one and the same operation group, the safety of the cryptoprocessor is not optimized to a hundred percent, it is however increased considerably compared to a randomly selected operation code.

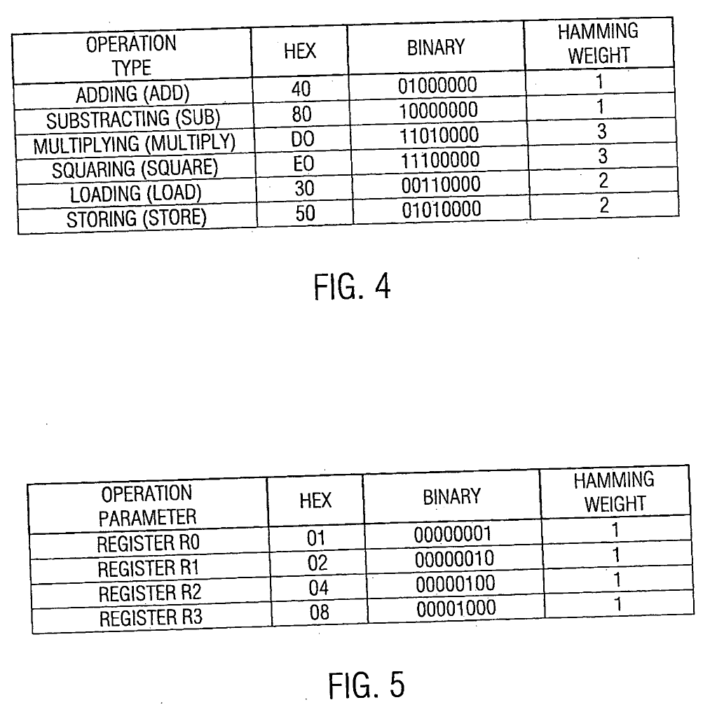

With an exemplary operation set, as it will be explained in the following referring to FIGS. 4, 5 and 6, each operation consists of a first part, specifying an operation type, and of a second operation part, specifying an operation parameter. As it is illustrated in FIG. 4, six different operation types exist for the exemplary operation set illustrated here, i.e. the operation types adding (ADD), subtracting (SUB), multiplying (MULTIPLY), squaring (SQUARE), loading (LOAD) and storing (STORE). The hexadecimal illustration of the individual operation types is illustrated in the second column of FIG. 3. In the third column of FIG. 3 the binary illustration is shown, while in the fourth column of FIG. 4 the Hamming weight of the individual operation type codes of the third column is indicated.

In FIG. 5 four different operation parameters are illustrated, i.e. the operation parameters R0, R1, R2 and R3. In the second column of FIG. 5 the hexadecimal illustration for each operation parameter is shown, while in the third column of FIG. 5 the binary operation parameter code is given. The last column of FIG. 5 again shows the Hamming weight of each operation parameter code of the third column of FIG. 5.

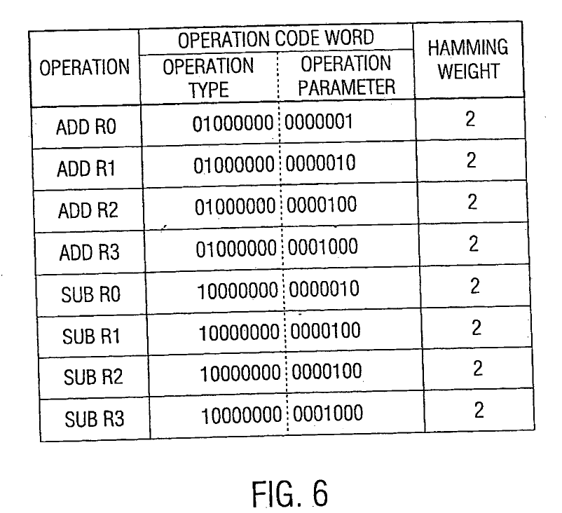

The operation architecture illustrated in FIGS. 4 and 5 refers to a so-called accumulator processor architecture, that the processor illustrated in FIG. 2 comprises as an example. A complete operation code word in the operation architecture illustrated here includes an upper portion which is also referred to as nibble, which specifies the operation type, and a lower portion, which is also referred to as nibble, for the operation parameter code. An operation code word shown in FIG. 6 therefore includes 16 bit, wherein the upper eight bits specify the operation type, while the lower eight bits specify the operation parameter. The operation add RO illustrated in the first line of FIG. 6, which means, if expressed in words, that the content of the register R0 is to be added to the accumulator register 24 of FIG. 2, includes two binary ones with the inventive operation code used in FIG. 6. In other words this means that the hamming weight for the operation code word associated with the operation add R0 equals 2.

With the embodiment of the present invention described herein, the circuit performing an operation, i.e. processing an operation code word is a CMOS circuit, wherein a characteristic of the circuit, like for example the current consumption of the circuit, does not depend on the idle state but on the switching processes performed when processing the operation code word.

As with the preferred processor described herein before each reloading of an operation code word into the processor the control input into the processor is set to 0, the number of ones in an operation code word is directly proportional to the power consumption of the processor when processing the operation code word, i.e. to the number of switching events.

The setting to zero of the control input may for example be achieved by inserting a zero operation, which is also referred to as NOP (no operation), wherein the operation code for the NOP includes only zeros, so that all control lines are set to zero. If the NOP is encoded using only ones, this has the same effect, as the state transitions at the control input are decisive.

The most preferred operation code for this special processor therefore includes operation code words for operations from an operation group comprising an identical Hamming weight, i.e. for which the number of ones in the operation code word is equal. For other processor architectures and for other processor operation modes, respectively, in which an initializing of the control inputs of the processor to 0 is not performed before every operation loading, other operation code characteristics than the Hamming weight of an operation code word may be used.

As it was already outlined, the division algorithm shown in FIG. 3 includes two operations adding, subtracting in step 2, which are located in one operation group. For the operation architecture described in the tables of FIGS. 4 and 6 this means that the Hamming weight of the operation type code for the adding operation is identical to the Hamming weight for the operation art code of the subtracting operation (SUB).

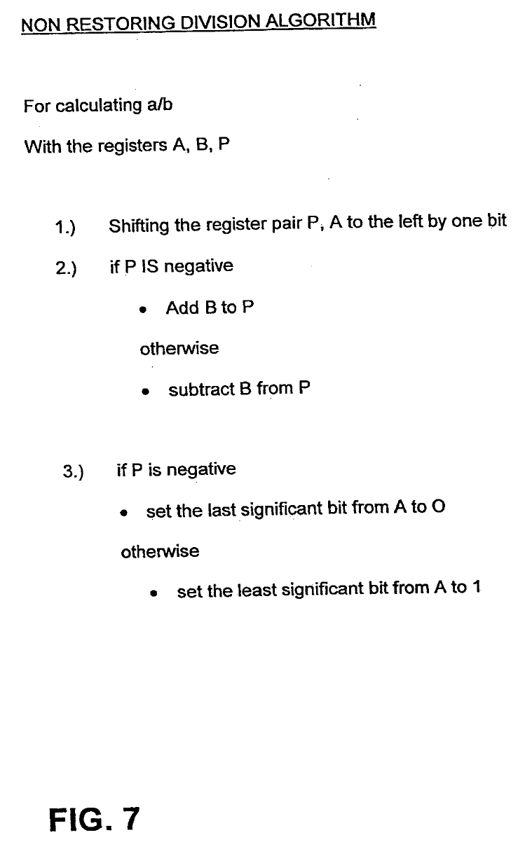

It is further preferred to select the operation parameter code identically for each operation parameter, as it is illustrated in FIG. 5. FIG. 6 therefore shows an operation group comprising eight individual operations and individual operation code words, respectively, all comprising the same Hamming weight. If now operation code words according to FIG. 6 are used for the alternative operations used in the second step of FIG. 7, as it is the case with the present invention, then no side-channel attack will provide an indication whether P is negative or not.

Further operation groups result from this, when the operation ADD in the table illustrated in FIG. 6 is replaced by the operation MULTIPLY, and when the operation art code in FIG. 6 is further replaced by the corresponding operation type code for the multiply operation of FIG. 4. Additionally, the operation “SUB” in FIG. 6 is to be used for the operation “SQUARE” and further the operation type code from FIG. 4 is to be used for the square operation so that a further operation group results analogous to FIG. 6, however with the operation types multiply and square.

A further operation group is obtained, when the process described using the operation group with the operation types multiply and square is performed, now, however, for the operations load and store.

From FIG. 7 it may further be seen, that also the two operations to be performed alternatively from the third step of the algorithm are to be grouped into one operation group, so that when these two operations comprise the same Hamming weight a side-channel attack will not allow any indications regarding the fact whether the content of the register P is positive or negative after step 2.

It is further noted that an operation group needs not necessarily include any operations illustrated in FIG. 6. All operations listed tabularly in FIG. 6 comprise the same Hamming weight, so that also smaller operation groups may be formed which—depending on the cryptographic program—may include at least two operations of the operations listed in FIG. 6.

The inventive concept is provided for the protection of cryptographic programs wherein the sequence of the program directly depends on the secret data. Using suitable measurement methods, like for example a current analysis or an electromagnetic radiation, it is possible to analyze the flow of the program corresponding to the secret date. Therefore it is possible that the value of a certain bit of the secret key directly corresponds to a pair like for example ADD/SUB, SQUARE/MULTIPLY or STORE Ri/STORE Rj, etc. As such pairs are different due to the Hamming weight of their opcode in normal operation sets, wherein this Hamming weight for example influences the current profile of the complete chip in a natural way, up to now a potential flaw against side-channel attacks existed which is eliminated due to the inventive concept. According to the invention, a program analysis provides critical operation pairs which are used in practice, as well as an operation code which is achieved by a homogenization of the Hamming weight of critical operation pairs. In particular for an operation architecture comprising an upper portion for the operation type and a lower portion for the operation parameter it is preferred that the operation type and the corresponding register encodings comprise an identical Hamming weight, whereby a complete homogenization of the Hamming weight of critical pairs is achieved.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Device for generating an operation code comprising a plurality of operation code words, wherein each operation code word is associated with an operation from a set of operations, comprising:
a provider for providing an operation group comprising operations from an operation set, wherein the operations from the operation group are to be performed alternatively to each other depending on a decision within a program; and
an allocator for allocating operation code words to the operations of the operation group, wherein the allocated code words are different from each other and implemented such that a characteristic of a circuit detectable by measuring, which depends on a processing of the operation code words, lies within a predetermined range for the operation code words of the operation group, wherein the predetermined range is small or substantially zero.

2. Device according to claim 1,
wherein the characteristic detectable by a measuring includes a current consumption, a power consumption, a time consumption and/or an electromagnetic radiation in performing an operation code word by the circuit.

3. Device according to claim 1,
wherein the allocator for allocating is arranged in order to allocate operation code words to the operations of the operation group, whose Hamming weight is equal.

4. Device according to claim 1,
wherein an operation code word includes an operation type code for a type of operation and an operation parameter code for an operation parameter, wherein the operation parameter code comprises the same Hamming weight in all operation code words.

5. Device according to claim 1, wherein the operation set comprises the following operation types:
adding, subtracting, multiplying, squaring, loading and storing.

6. Device according to claim 5, wherein operations with the operation types add and subtract or multiply/square, or load and store, are respectively located in an individual operation group.

7. Device according to claim 5, wherein the operation parameters comprise four registers.

8. Device according to claim 1,
wherein one operation group comprises two operations comprising operation code words whose operation type codes are identical and whose operation parameter codes are different.

9. Device according to claim 1, wherein the provider for providing comprises an analyzer for analyzing the program, wherein the analyzer for analyzing is implemented in order to determine decisions within the program in order to detect operations which are performable alternatively to another depending on a decision, and to group the detected operations into the same operation group.

10. Method for generating an operation code comprising a plurality of operation code words, wherein each operation code word is associated with an operation from a set of operations, comprising the following steps:
providing an operation group comprising operations from an operation set, wherein the operations from the operation group are performable alternatively to one another depending on a decision within a program; and
allocating of operation code words to the operations of the operation group, wherein the allocated code words are different from one another and implemented such that a characteristic of a circuit detectable by measuring, which depends on a processing of the operation code words lies in a predetermined range for the operation code words of the operation group, wherein the predetermined range is small or substantially zero.

11. Device for performing a program with a sequence of operations, wherein an operation is represented by a plurality of operation code words by an operation code word of an operation code, wherein the operation code is generated by a device for generating an operation code comprising a plurality of operation code words, wherein each operation code word is associated with an operation from a set of operations, having a provider for providing an operation group comprising operations from an operation set, wherein the operations from the operation group are to be performed alternatively to each other depending on a decision within a program; and an allocator for allocating operation code words to the operations of the operation group, wherein the allocated code words are different from each other and implemented such that a characteristic of a circuit detectable by measuring, which depends on a processing of the operation code words, lies within a predetermined range for the operation code words of the operation group, wherein the predetermined range is small or substantially zero, the device for performing comprising:
an operation encoder for receiving an operation and for outputting an operation code word for the operation according to the operation code; and
a processor for processing the output operation code word.

12. Method for performing a program with a sequence of operations, wherein an operation is represented by an operation code word of an operation code with a plurality of operation code words, wherein the operation code is generated by a method for generating an operation code comprising a plurality of operation code words, wherein each operation code word is associated with an operation from a set of operations, comprising the steps of providing an operation group comprising operations from an operation set, wherein the operations from the operation group are performable alternatively to one another depending on a decision within a program; and allocating of operation code words to the operations of the operation group, wherein the allocated code words are different from one another and implemented such that a characteristic of a circuit detectable by measuring, which depends on a processing of the operation code words lies in a predetermined range for the operation code words of the operation group, wherein the predetermined range is small or substantially zero, the method for performing comprising:
encoding a received operation and outputting an operation code word for the operation according to the operation code; and
processing the output operation code word.

13. Storage with a stored operation code generated according to a method for generating an operation code comprising a plurality of operation code words, wherein each operation code word is associated with an operation from a set of operations, with the steps of providing an operation group comprising operations from an operation set, wherein the operations from the operation group are performable alternatively to one another depending on a decision within a program; and allocating of operation code words to the operations of the operation group, wherein the allocated code words are different from one another and implemented such that a characteristic of a circuit detectable by measuring, which depends on a processing of the operation code words lies in a predetermined range for the operation code words of the operation group, wherein the predetermined range is small or substantially zero.
